(19) United States
(12) Patent Application Publication
(10) Pub. No.: US 2026/0257861 A1
(43) Pub. Date: Sep. 3, 2026

(54) ACCESS STATION

(71) Applicant: AutoStore Technology AS, Nedre Vats (NO)

(72) Inventor: Øystein Gjerdevik, Skjold (NO)

(21) Appl. No.: 18/875,235

(22) PCT Filed: Sep. 25, 2023
(86) PCT No.: PCT/EP2023/076391

§ 371 Date: Dec. 16, 2024

(30) Foreign Application Priority Data
Sep. 26, 2022 (NO) 20221015

(51) Int. Cl. B65G 1/06; F25D 13/02; F25D 25/04

(52) U.S. Cl. CPC B65G 1/065; F25D 13/02; F25D 25/04

(57) ABSTRACT

An access station for a storage system comprising a station housing having an access opening and a moveable cover for closing the access opening, and a transport system for moving a container between a first position and a second position, wherein in the first position the container is removed from the access opening, and in the second position the container is arranged below the access opening, where a seal is arranged at a periphery of the access opening, the seal being configured to seal against a container when the container is in the second position.

### FIELD OF THE INVENTION

The present invention relates to a storage system for containers, and an access station for such a storage system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a horizontal grid-based rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201,301,401 so that the position of the lifting frame 404d with respect to the vehicle 201,301,401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking and/or a stocking station where product items are removed from or positioned into the storage containers 106. In an access station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

Access stations suitable for the storage system in FIG. 1 are disclosed in e.g. WO 2012/026824 A1, WO 2021/259644 A1, WO 2017/211640 A1 and WO 2022/122434 A1.

A conveyor system comprising any suitable conveying means such as a conveyor belts or carriage may be employed to transport a storage container between the port columns 119,120 and a position within the access station at which an operator may access the storage container.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lift device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In many instances it may be desirable to control the conditions, such as the temperature, moisture and oxygen content of the atmosphere, within the storage system in an efficient manner. It may also be desirable to protect an operator working at an access station from the conditions within the storage system.

The aim of the present invention is to provide an access station allowing for a more efficient control of the conditions within a storage system as well as avoiding the exposure of an operator to said conditions.

### SUMMARY OF THE INVENTION

The present invention is defined in the attached claims and in the following:

In a first aspect, the present invention provides an access station for a storage system, the access station comprises a station housing, the station housing having an access opening and a moveable cover for closing the access opening, and a transport system for moving a container between a first position and a second position, wherein
in the first position the container is removed from the access opening, and
in the second position the container is arranged below the access opening; wherein
a seal is arranged at a periphery of the access opening, the seal being configured to seal against a container when the container is in the second position.

In the first position, the container may be transferred between the first position and a storage position in the storage system. In the first position the container may be laterally removed from the access opening, i.e. is arranged at a position away from the access opening.

The access opening is in an upwards surface of the station housing for allowing an operator to access items in a container therein. The access opening may extend from the station housing to a container arranged in the first position. The seal may function as an extension of the access opening, i.e. sealing any gap between the access opening and a container arranged in the second position. In the second position, the container is arranged below the access opening to allow access to items in the container by an operator.

The seal is configured to minimize or prevent flow of air/gas between an internal space of the access station and the surroundings when sealing against a container arranged in the second position. In other words, the seal may be configured to close off any gap formed between an upper rim or horizontal periphery of the storage container and the periphery of the access opening.

In an embodiment of the access station, the seal may be configured to seal against an upper rim or horizontal periphery of a container when the container is in the second position.

In an embodiment of the access station, the seal may extend along the entire periphery of the access opening.

In an embodiment of the access station, the seal may have a sealing side facing a container when the container is in the second position. The sealing side is the side or surface of the seal configured to interact with an upper rim of a storage container.

In an embodiment of the access station, the seal may be a brush seal or a rubber seal. The term <<rubber seal>> is intended to mean any seal made in a suitable resilient polymeric material, including synthetic or natural elastomeric polymers. The brush seal may be most advantageous when the upper rim of the container is horizontal during the movement into the second position since it facilitates a sliding movement between the seal and the upper rim. If the upper rim of the container is inclined relative to the horizontal during the movement into the second position a rubber seal may provide the optimal sealing.

In an embodiment of the access station the seal has a rectangular form. The access opening may comprise a rectangular opening in an upwards facing surface of the station housing. The seal may be arranged or connected along an internal surface of the housing at the periphery of the access opening.

In an embodiment of the access station the seal has a centre opening. The centre opening may have a centreline being colinear with a centreline of the access opening. The dimensions, i.e. the area, of the centre opening of the seal may be substantially equal to the area of the access opening.

In an embodiment of the access station, the seal is inclined and the transport system is configured to similarly incline the container towards the seal when the container enters the second position, such that an upper rim of the container is pushed towards a sealing side of the seal when the container is in the second position.

In an embodiment, the access station may feature a control system connected to the cover, i.e. connected to a motor or actuator moving the cover. The control system may be configured to reveal/open the access opening by moving the cover away from the access opening when a container, to which container access is required by an operator, is in the second position. Access may be required e.g. when an item is to be retrieved from the container.

In an embodiment of the access station, the control system may be configured to close the access opening before the container is moved from the second position to the first position. The access opening may be closed by moving the cover over the access opening. That is the cover is moved to close off the access opening such that an operator may not access the container and air may not move through the access opening.

In an embodiment of the access station, the cover is configured to move above the seal when the access opening is opened and closed. The cover may move above the seal and below an upper part of the access opening when the access opening is revealed/opened and closed, i.e. to provide or deny access to a container in the second position

In an embodiment of the access station, at least a section of the station housing comprises insulation material to minimize heat transfer between an internal space of the access station and the surroundings.

In an embodiment of the access station, the transport system may provide a first container accommodating position and a second container accommodating position, and may be configured to move a container between the first container accommodating position and the second container accommodating position such that the container is moved between the first position and the second position, respectively.

In an embodiment of the access station, the transport system may comprise a container holder, the container holder configured to support a container and arranged to be moveable between the first container accommodating position and the second container accommodating position.

In an embodiment of the access station, the transport system may comprise a container holder configured to support and move a container between the first position and the second position. The container holder may be inclined when the container moves into the second position such that the upper rim is pushed against the seal when the container is in the second position.

In an embodiment of the access station, the transport system may comprise a set of rails and a carriage configured to move the container holder along the rails.

In a second aspect, the present invention provides a storage system for containers, the storage system comprising an access station according to any embodiment of the first aspect.

In an embodiment, the storage system may feature a port column through which containers may be transferred in a vertical direction, the port column being arranged above the access station such that a container may be delivered to, or retrieved from, the first position via the port column.

In an embodiment, the storage system may comprise storage columns in which containers are stored in stacks, a rail grid and container handling vehicles for moving containers and a rail grid upon which the container handling vehicles may move in two perpendicular horizontal directions. The container handling vehicles may feature a lifting device configured to retrieve a container from a storage column and lower the container via a port column to the first position in the access station.

In an embodiment, the storage system may comprise a framework structure in which containers are stored. The storage system may comprise walls which at least partially covers the framework structure such that the temperature and or atmosphere, i.e. the conditions, within the framework structure is different from the surroundings. The external sides of the framework structure may be covered in insulated plates.

In a third aspect, the present invention provides a method of preventing air flow between an internal space of an access station according to any embodiment of the first aspect and the surroundings during retrieval of an item from a container, the method comprising the steps of:
arranging the container in the first position;
moving the container to the second position such that the seal seals against an upper rim of the container;
opening the access opening by moving the cover away from the access opening; and
retrieving an item from the container.

In an embodiment, the method may comprise the steps of:
closing the access opening; and
moving the container to the first position.

The method according to the third aspect may also be termed a method of dampening noise from a storage system according to any embodiment of the second aspect during operation of an access station according to any embodiment of the first aspect to retrieve an item from a container.

The term “storage system” is intended to encompass storage systems comprising any type of containers, e.g. bins, frames or supports/holders, that may accommodate any type of item, goods or merchandise, including growth media in which plants may be cultivated. In the latter case, the storage system may be used for vertical farming.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a first exemplary access station according to the invention.

FIG. 6 is a cross-sectional side view of the access station in FIG. 5.

FIG. 7 are cross-sectional side views of the access station in FIG. 5, wherein an access opening is closed.

FIG. 8 are cross-sectional side views of the access station in FIG. 5, wherein the access opening is open.

FIG. 9 is a perspective view of a second exemplary access station according to the invention.

FIG. 10 is a cross-sectional side view of the access station in FIG. 9.

FIG. 11 are cross-sectional side views of the access station in FIG. 9, wherein an access opening is closed.

FIG. 12 are cross-sectional side views of the access station in FIG. 9, wherein the access opening is open.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

As mentioned above, in many instances it may be desirable to control the conditions, such as the temperature, moisture and oxygen content of the atmosphere, within a storage system. In such cases it is also advantageous to protect an operator working at an access station from the conditions within the storage system.

Embodiments of an access station according to the invention which allow for a more efficient control of the conditions within a storage system as well as avoiding the exposure of an operator to said conditions are described below.

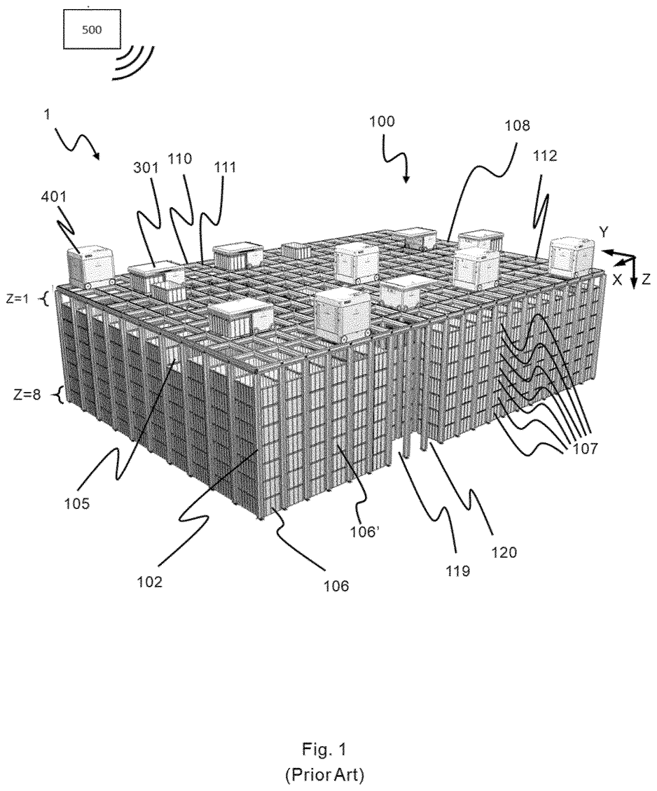

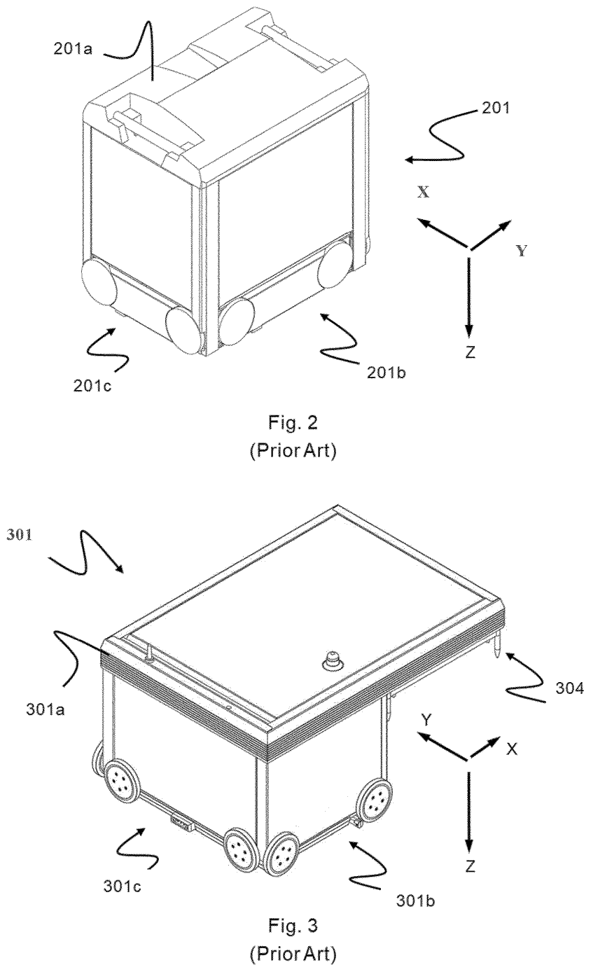

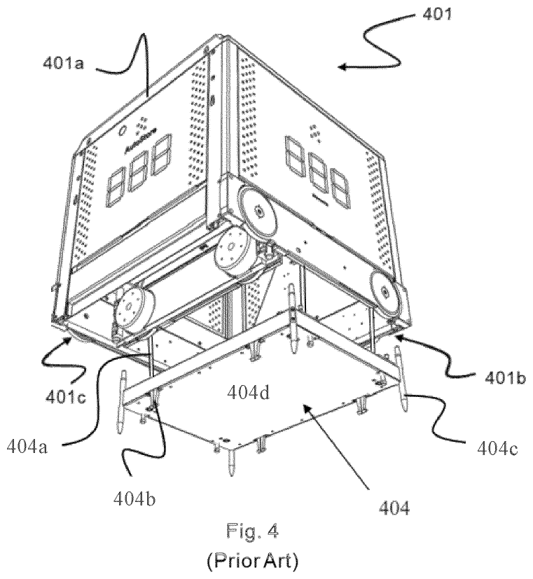

The access station 2,2′ according to the invention is intended for use in an automated storage and retrieval system, also termed a container handling system, having a framework structure 100 as described above in connection with FIGS. 1-3. The framework structure 100 comprises a plurality of upright members 102 (i.e. vertical column profiles) and a rail system 108 forming a rail grid extending in the first direction X and the second direction Y. The rail system 108 features a first set of parallel rails 110 in the first direction and a second set of parallel rails 111 in the second direction. The upright members 102 define storage columns 105, in which containers 106 may be stacked on top of each other, and port columns 119,120 through which containers may be transferred from/to the access station 2,2′. That is, the access station 2,2′ may be operatively connected to a port column. The containers of the automated storage and retrieval system may be configured to fulfil various functions, such as storage of items and goods and growth modules for plants. In the latter case, the automated storage and retrieval system may also be termed a vertical farming system.

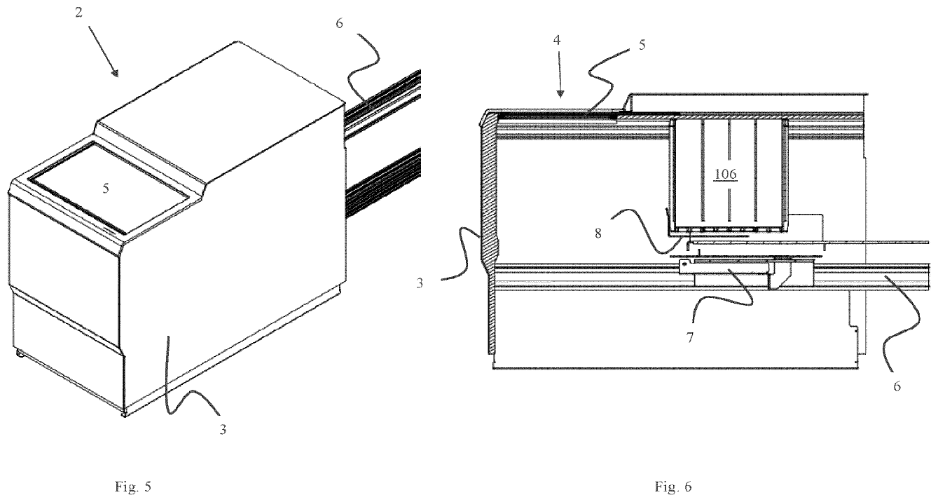

A first exemplary embodiment of an access station according to the invention is shown in FIGS. 5-8.

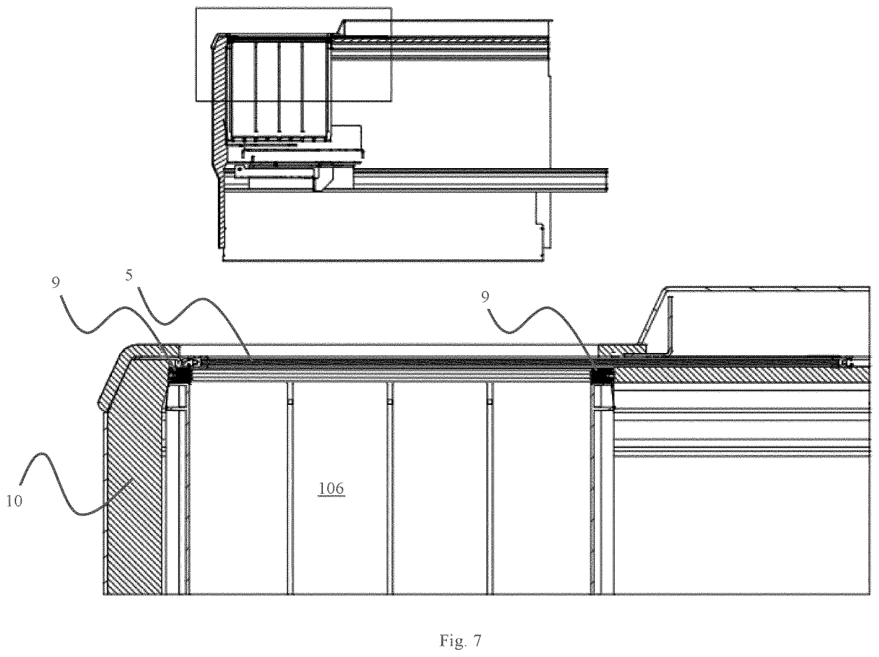

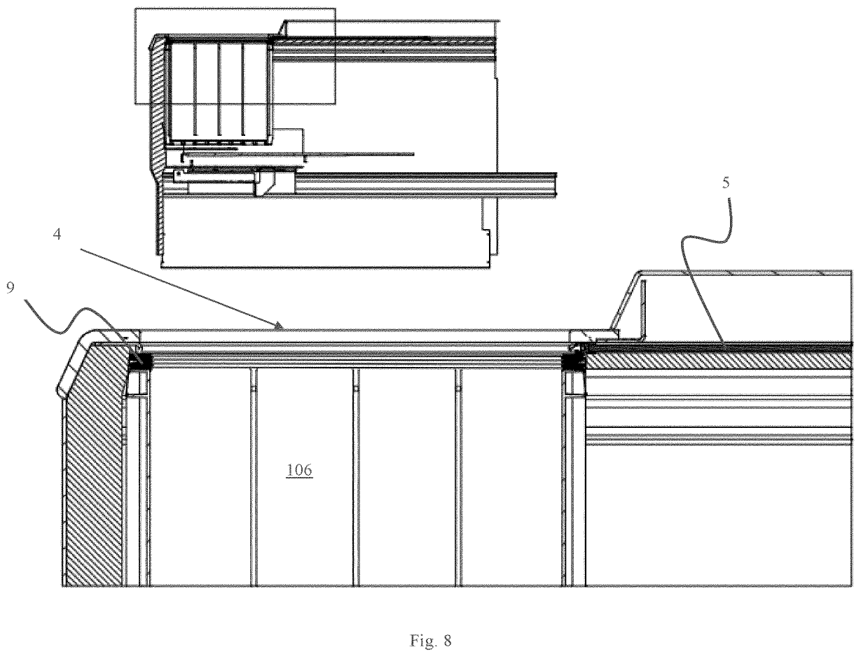

The access station comprises a station housing 3 having an access opening 4, a moveable cover 5 for closing/opening the access opening, a transport system 6,7 for moving a container 106 between a first position and a second position, and a seal 9. In the first position, the container 106 is removed from, i.e. arranged away from, the access opening 4, see FIG. 6. In the second position, the container 106 is arranged below the access opening 4, see FIGS. 7 and 8.

The seal 9 is arranged at a periphery of the access opening 4 and is configured to seal against an upper rim 11 of the container when the container 106 is in the second position. The seal is a rectangular shaped brush seal extending along the entire periphery of the access opening 4. A brush seal is advantageous as it allows for optimal sealing towards the container when the container is only moved in a horizontal direction into the second position. A rubber seal may also be used, but optimal sealing or function may in that case require a slight vertical movement of the container towards the seal.

From the first position, the container 106 may be transferred for storage in the storage system. A container 106 may similarly be transferred from storage in the storage system to the first position.

The transport system comprises a set of rails 6, a carriage 7 and a container holder 8. The carriage 7 is configured to move the container holder 8 along the rails 6 between the first position and the second position. In the first position, the container may be arranged in or below a port column 119,120, such that the container may be transferred via the port column and subsequently stored in a storage column 105.

The station housing 3 may advantageously be insulated using an insulation material 10 to minimize heat transfer between an internal space of the access station 2 and the surroundings.

The access station 2 may feature a control system connected to the cover 5. The control system being configured to reveal or open the access opening 4 by moving the cover 5 away from the access opening when a container 106, from which an item is to be retrieved, is in the second position. The control system is preferably configured to close off the access opening 4 before the container 106 is moved from the second position to the first position. In this manner, the internal atmosphere of the access station 2 is always kept from exiting the access opening 4, either due to the sealing against the container or the closure of the access opening when a container is not present in the second position. Similarly, surrounding air is prevented from entering the access station and potential icing and condensation within the access station may be prevented or minimized in case the storage system is cooled.

The cover 5 does not interfere with the function of the seal by being configured to move above the seal 9 when the access opening 4 is opened and/or closed off.

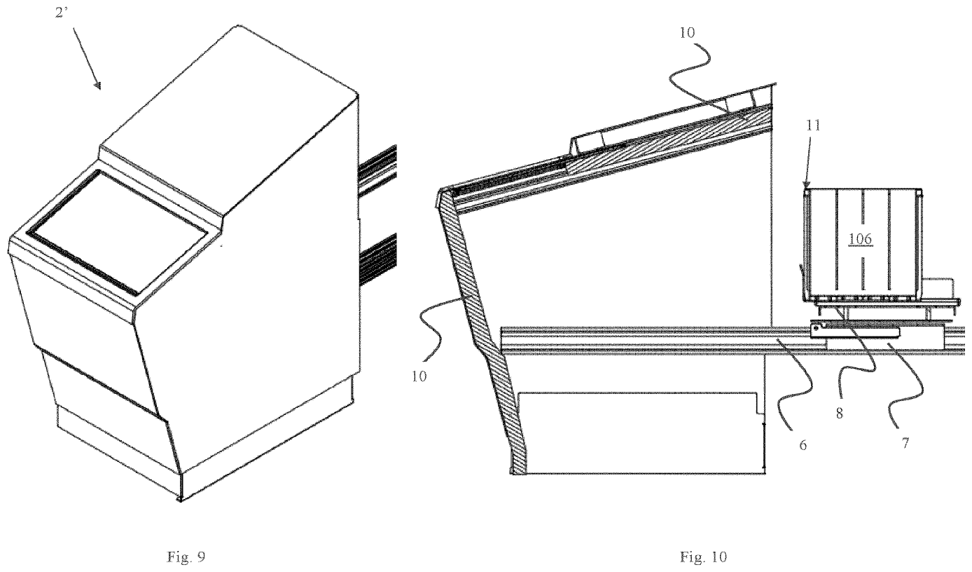

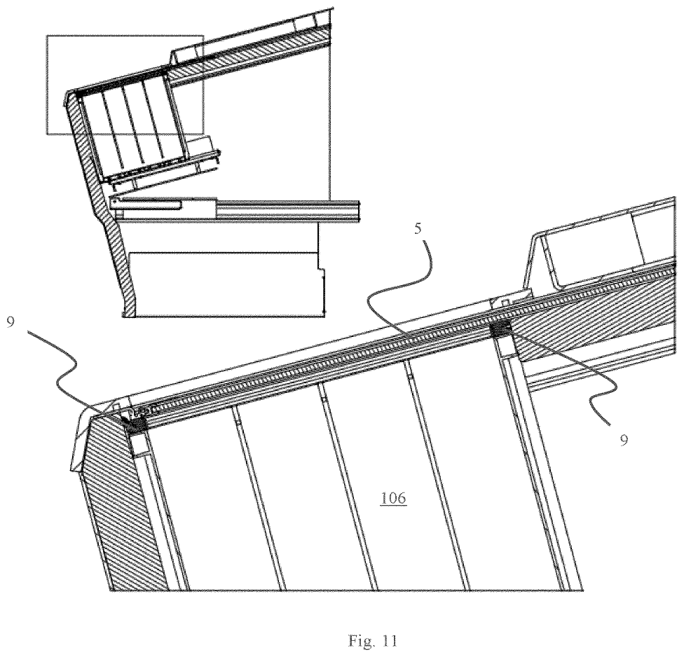

A second exemplary access station according to the invention is shown in FIGS. 9-12. The main differentiating feature in view of the access station in FIGS. 5-8 is that the the container holder 8 may be inclined when the container 106 moves into the second position such that the upper rim 11 is pushed against the seal 9 when the container is in the second position. The seal may preferably be a rubber seal, i.e. made in a suitably resilient polymeric material. The container holder 8 is pivotally connected to the carriage 7.

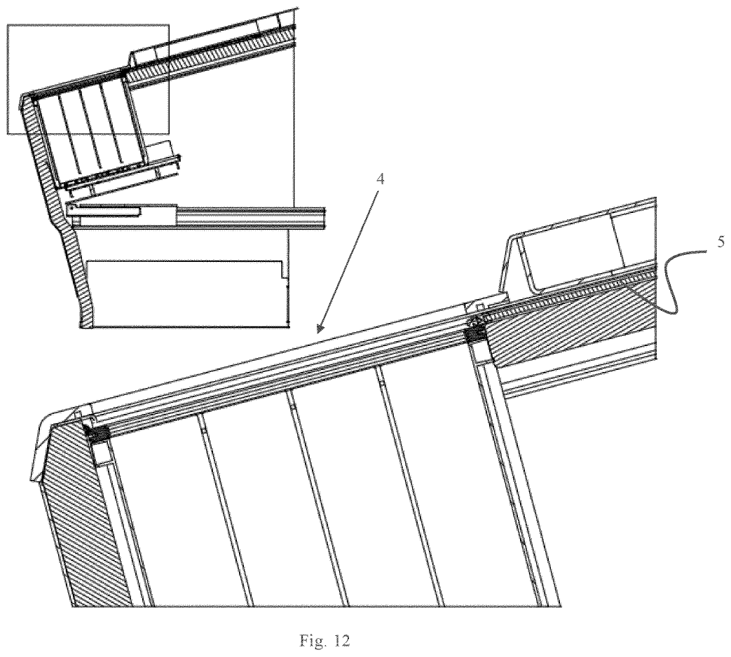

The access station 2,2′ according to the invention is highly advantageous in that air flow between an internal space of the access station (i.e. the internal space in communication with an internal space of the framework structure of a storage system) and the surroundings may be prevented or minimized during retrieval of an item from a container 106. The retrieval of an item may be performed by the following steps:
arranging the container 106 in the first position; the container 106 may e.g. be arranged in the first position by use of a container handling vehicle 201,301,401 to lower the container 106 via a port column 119,120 to the access station.
moving the container 106 to the second position such that the seal 9 seals against an upper rim 11 of the container 106, see FIGS. 7 and 11; the movement of the container 106 from the first to the second position may be in a substantially horizontal direction, optionally including a minor upwards or vertical movement to push the container towards the seal when in the second position.
revealing or opening the access opening 4 by moving the cover 5 away from the access opening 4, see FIGS. 8 and 12; and
retrieving an item from the container 106.

When the item is retrieved/picked by a human or robotic operator, the container may be returned to storage by:
moving the cover 5 to close off the access opening 4; and
moving the container 106 to the first position, in which the container 106 may e.g. be retrieved by a container handling vehicle 201,301,401 or container lift for subsequent storage.

The exemplary access stations feature a specific transport system comprising rails 6, a moveable carriage 7 and a container holder 8. In other embodiments, the access station may feature any suitable type of transport system such as conveyor belts/rollers as disclosed in WO 2019/206971 A1 and container holders arranged on pivotable arms as disclosed in WO 2022/112153 A1 and WO 2012/026824 A1. In addition to preventing exposure of the surroundings to the above-mentioned atmospheric condition in a storage system, and vice versa, the present inventive access station will also dampen the noise from within a storage system. The dampening of noise experienced by a human operator during operation of the access station is a further advantage of the present invention.

### LIST OF REFERENCE NUMBERS

1 Prior art automated storage and retrieval system
2,2′ Access station
3 Station housing
4 Access opening
5 Cover
6 Rail
7 Carriage
8 Container holder
9 Seal
10 Insulation material
11 Upper rim of container
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1.-16. (canceled)

17. An access station for a storage system, the access station comprising a station housing, the station housing having an access opening and a moveable cover for closing the access opening, and a transport system for moving a container between a first position and a second position, wherein
in the first position the container is removed from the access opening, and
in the second position the container is arranged below the access opening; wherein a seal is arranged at a periphery of the access opening, the seal being configured to seal against a container when the container is in the second position.

18. The access station according to claim 17, wherein the seal is configured to seal against an upper rim or horizontal periphery of a container when the container is in the second position.

19. The access station according to claim 17, wherein the seal extends along an entire periphery of the access opening.

20. The access station according to claim 17, wherein the seal has a sealing side facing a container when the container is in the second position.

21. The access station according to claim 17, wherein the seal is a brush seal or a rubber seal.

22. The access station according to claim 17, wherein the seal has a rectangular form and a centre opening.

23. The access station according to claim 17, featuring a control system connected to the cover, the control system being configured to reveal the access opening by moving the cover away from the access opening when a container to which access is required is in the second position.

24. The access station according to claim 23, wherein the control system is configured to close the access opening before the container is moved from the second position to the first position.

25. The access station according to claim 17, wherein the cover is configured to move above the seal when the access opening is revealed and closed.

26. The access station according to claim 17, wherein at least a section of the station housing comprises insulation material to minimize heat transfer between an internal space of the access station and surroundings.

27. The access station according to claim 17, wherein the transport system comprises a container holder configured to support and move a container between the first position and the second position.

28. The access station according to claim 27, wherein the transport system comprises a set of rails and a carriage configured to move the container holder along the rails.

29. A storage system for containers, the storage system comprising an access station according to claim 17.

30. The storage system according to claim 29, wherein the storage system features a port column through which containers may be transferred in a vertical direction, the port column being arranged above the access station such that a container may be delivered to, or retrieved from, the first position via the port column.

31. A method of preventing air flow between an internal space of an access station according to claim 17 and surroundings during retrieval of an item from a container, the method comprising:
arranging the container in the first position;
moving the container to the second position such that the seal seals against an upper rim of the container;
revealing the access opening by moving the cover away from the access opening; and
retrieving an item from the container.

32. The method according to claim 31, further comprising:
closing the access opening; and
moving the container to the first position.
